(19) United States
(12) Patent Application Publication
(10) Pub. No.: US 2016/0348353 A1
(43) Pub. Date: Dec. 1, 2016

(54) Portable Rock Filter

(71) Applicant: John Russell Combs, McKinney, TX (US)

(72) Inventor: John Russell Combs, McKinney, TX (US)

(21) Appl. No.: 14/725,768

(22) Filed: May 29, 2015

(51) Int. Cl. E03F 5/06; E03F 1/00; C02F 1/00; E03F 5/04

(52) U.S. Cl. CPC E03F 5/06; E03F 5/0404; E03F 1/00; C02F 1/00; C02F 2103/06

(57) ABSTRACT

A portable rock filter is described as a tool for use in erosion control and inlet protection. The filter is comprised of a double wrap of PVC coated wire mesh around a core of graded rocks. The portable rock filter may be used for inlet protection.

### BACKGROUND

1. Field of the Invention

The present invention relates generally to tools and methods used to prevent erosion and to prevent sediment from entering drainage systems.

2. Description of Related Art

During construction or after earth moving projects the ground can be susceptible to erosion and runoff can carry large amounts of sediment. That erosion can damage a site and the sediment can clog drainage systems. Complex systems are often required to keep sediment out of drainage systems.

Currently fences are often used to filter run-off and numerous inlet protection devices are employed with varying results.

A need exists, therefore, for a versatile tool and method for filtering run-off and protecting inlets from sediment intrusion.

All references cited herein are incorporated by reference to the maximum extent allowable by law. To the extent a reference may not be fully incorporated herein, it is incorporated by reference for background purposes and indicative of the knowledge of one of ordinary skill in the art.

### BRIEF SUMMARY OF THE INVENTION

The problems presented in the art are addressed by a portable rock filter; the filter comprising graded stone and wire mesh wrapped around the graded stone. The wire mesh may be double wrapped around the graded stone. The wire mesh is PVC coated. The portable rock filter may have at least one handle attached to the wire mesh.

The problems presented in the art are addressed by an inlet protection system comprised of a wire grid formed to have a flat section, a vertical section and a cover section and a plurality of portable rock filters placed on the flat section, each rock filter comprising graded stone; and wire mesh wrapped around the graded stone. The wire mesh may be double wrapped around the graded stone. The wire mesh is PVC coated. The portable rock filters may have at least one handle attached to the wire mesh.

Other objects, features, and advantages of the present invention will become apparent with reference to the drawings and detailed description that follow.

### BRIEF DESCRIPTION OF THE DRAWINGS

FIG. 1 is a plan view of a portable rock filter;

FIG. 2 is a sectional view of the portable rock filter from FIG. 1;

FIG. 3 is a plan view of two portable rock filters being used for inlet protection; and

FIG. 4 is a sectional view of the inlet protection shown in FIG. 3.

### DETAILED DESCRIPTION

All references cited herein are incorporated by reference to the maximum extent allowable by law. To the extent a reference may not be fully incorporated herein, it is incorporated by reference for background purposes and indicative of the knowledge of one of ordinary skill in the art.

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

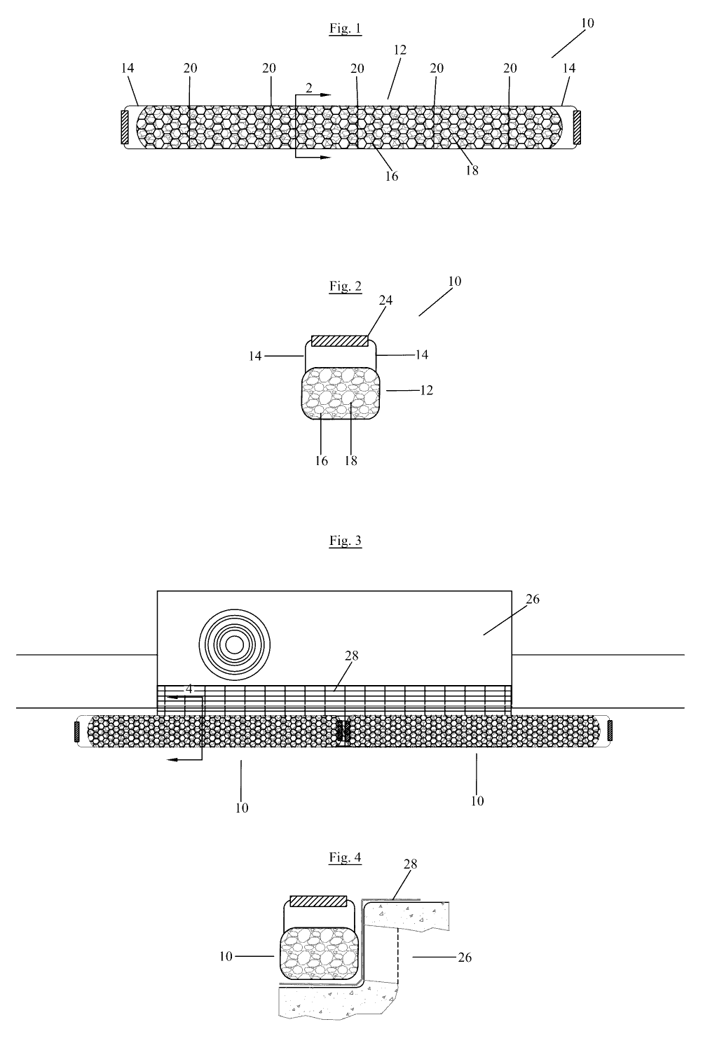

FIG. 1 is a plan view of a portable rock filter 10 having a body 12 and handles 14. Body 12 is formed of a double wrap of PVC coated wire mesh 16 filled with graded filter stone 18. It is typical for the coated wire mesh 16 to have an opening size of about one inch and the graded stone 18 to be about 1.5″ to 2″ in size. Wire ties 20 are spaced along the portable rock filter 10 to secure the mesh 16 about the stone 18. For uses where a larger stone 18 is desired the mesh 16 opening size would be larger. For uses where a smaller stone 18 size is desired a smaller mesh 16 opening size would be used. Combined, the mesh 16 and stone 18 act to reduce the run-off speed of water flowing through them and to thereby trap or filter out some of the sediment in the run-off.

FIG. 2 is a sectional view of the portable rock filter 10 from FIG. 1 showing a handle 14 being comprised of a wire loop 22 and a grip 24 along the wire loop 22. Also shown from this sectional view are the wire mesh 16 and the rock 18. The wires mesh 16 is formed to give the filter 10 a somewhat squared profile which makes for secure placement on flat surfaces, such as roads or sidewalks.

FIG. 3 is a plan view of two portable rock filters 10 being used for inlet protection at a typical curb inlet 26. A stiff wire grid 28 is first placed to cover the inlet 26 so that large items, such as the portable filter 10 are not allowed into the inlet 28. The grid should be shaped so that a portion is laid out in front of the inlet, and another portion covers the inlet and a third portion extends over the top of the inlet. The filters 10 are placed on the portion of the grid 28 extending in front of the inlet 26 and act to secure the grid 28 in place. In this example two filters 10 are being used together to extend beyond the opening width of inlet 26. Typically the filters 10 should extend at least a foot beyond the inlet 26.

FIG. 4 is a sectional view of the inlet protection shown in FIG. 3 and clearly shows the grid 28 extending under the filters 10 and then up behind the filters 10 and over the top of the inlet 26. The grid 28 allows the filters 10 to be sized so that the tops of the filters 10 are about two inches below the top of the inlet 26 opening. This allows for water to go over the filters 10 in very high run-off volume situations where drainage may be more critical than sediment control.

In all of the above applications the wire mesh 16 is double wrapped to provide a secure enclosure around the graded stone 18. The wire mesh 16 is preferably a coated wire mesh 16, such as PVC coated wire mesh commercially available. The PVC coated wire mesh 16 has been found to have surprising benefits in this application over both galvanized wire mesh 16 and untreated wire mesh 16. Using coated wire mesh 16 reduces rusting, reduces tears, provides a lightweight structure, is aesthetically more pleasing and holds the stone 18 within the filter 10 better. The PVC coated mesh 16 makes the portable filters 10 actually portable in that they may be emptied of the stone 18 and stored for later reuse without worry about structural damage or decay during storage. Also, the PVC coated wire mesh 16 is easier to inspect when the filters 10 are being cleaned or emptied so that damage may be addressed.

It should be apparent from the foregoing that an invention having significant advantages has been provided. While the invention is shown in only a few of its forms, it is not just limited but is susceptible to various changes and modifications without departing from the spirit thereof.

1. A portable rock filter, the filter comprising:
graded stone; and
wire mesh wrapped around the graded stone.

2. The portable rock filter of claim 1 wherein:
the wire mesh is double wrapped around the graded stone.

3. The portable rock filter of claim 2 wherein:
the wire mesh is PVC coated.

4. The portable rock filter of claim 1 further comprising:
at least one handle attached to the wire mesh.

5. An inlet protection system comprised of:
a wire grid formed to have a flat section, a vertical section and a cover section; and
a plurality of portable rock filters placed on the flat section, each filter comprising:
graded stone; and
wire mesh wrapped around the graded stone.

6. The system of claim 5 wherein:
the wire mesh is double wrapped around the graded stone.

7. The system of claim 6 wherein:
the wire mesh is PVC coated.

8. The system of claim 7 further comprising:
at least one handle attached to the wire mesh.
